(19) United States
(12) Patent Application Publication
(10) Pub. No.: US 2014/0188838 A1
(43) Pub. Date: Jul. 3, 2014

(54) INFORMATION SEARCH ENGINE, PROCESSING AND RATING SYSTEM

(71) Applicant: EDUARD MIKHAILOVICH STRUGOV, MOSCOW (RU)

(72) Inventor: EDUARD MIKHAILOVICH STRUGOV, MOSCOW (RU)

(21) Appl. No.: 13/729,054

(22) Filed: Dec. 28, 2012

(51) Int. Cl. G06F 17/30

(52) U.S. Cl. CPC G06F 17/30867
USPC 707/710

(57) ABSTRACT

Generally, the invention is relevant to computers and data processing and, in particular, covers the method for searching and further processing and collaborative rating the content of interest in a network environment. The invention is a search engine, processing and information rating system comprising at least one user terminal connectable to a server component comprising at least one database arranged as a set of alternatives associated with at least one criterion, an alternative search block and an alternative ranking block along with a block enabling a user to specify a score for any alternative by any criterion.

### BACKGROUND OF THE INVENTION

Generally, the invention is relevant to computers and data processing and, in particular, covers the method for searching and further processing and collaborative rating the content of interest in a network environment.

In a broad sense, the engineering solution subject matter covers a search engine, processing and content rating system which can also be used as a recommendation and analytical system accumulating users' scores, reviews and comments while users are involved in making a choice between a few alternatives. The system has a matrix-based graphical interface and associates said scores, reviews and comments with matrix cells; each said cell represents a certain alternative/criterion crossing point. The user is free to add/exclude any alternatives and criteria, to rank alternatives according to own preferences by assigning weights to a set of important criteria, and to collect/filter data arrays to obtain freely defined opinion surveys attributed to certain user groups.

From time to time we have to deal with various comparisons. Comparing various things, concepts, entities, or options and identifying analogies and dissimilarities between them in view of their attributes enable people to figure out a world view which is organized and classified in a certain way.

Marketing researches address buying behavior and decision making processes throughout the marketing concept evolvement. Development, of e-commerce made researchers refocus from satisfying needs and demands of target markets to satisfying needs and demands of consuming individuals, and led to relationship marketing emergence [G. L. Bagiev, A. N. Asaul. Business Engineering. CHAPTER 3. MARKETING AS ENTERPRENEURSHIP PHILOSOPHY AND TOOL]. Generally, buying decisions are made by consumers through comparing and evaluating options available in the market. Typically, consumers find it is easier to acquire information about products and services by using the click of a button on the Internet than by using phone calls and customer visits to several different bricks-and-mortar stores. Of course, so much information is available on the Internet that consumers can also become confused or overwhelmed [Consumer Behavior. Authors: Frank Kardes, Frank R. Kardes, Maria Cronley, Maria L. Cronley, Thomas Cline, Thomas W. Cline. Objective 4]. For example, today's search for cameras at amazon.com generates 2,216,100 results. In addition, it should be noted that lack of trust in online companies is a primary reason why many web users do not shop online.

Modern Internet development shows natural trends towards finding solutions for the above-mentioned problems. In 2003 Yahoo launched SmartSort, an interactive personalized tool enabling consumers to sort results of shopping searches. SmartSort was available across nine consumer electronics categories in Yahoo Shopping. SmartSort helped narrow the search for a specific product by taking a broad category like digital cameras, which has hundreds of choices, and asking a user to rank criteria (i.e. price, brand, optical zoom) according to importance. SmartSort then instantly recommended the top ten models based on the selected criteria. To further expedite the search, all product recommendations remained on one interface and were instantly refreshed when the consumer adjusted criteria sliders or scales, which either placed more or less value on a specific product attribute. The described tool can be attributed to so-called decision engines. When searching for the best match option the engine allows the user to specify the importance of criteria and then provides a list of those items that match the user's preferences. It should be noted that the above approach is not limited to e commerce and can be used to compare any alternatives, for example, to select the most suited one among applicants to fill a certain vacancy using applicants' CVs.

Consumers behave as limited information processors and are only able to consider about seven pieces of information at a time According to Häubl and Trifts [Häubl and Trifts 2000 Consumer Decision Making in Online Shopping Environments: The Effects of Interactive Decision Aids. Gerald Haubl (gerald.haeubl@ualberta.ca) and Valerie Trifts (trifts@datanet.ab.ca) (http://marketsci.highwire.org/content/19/1/4.abstract)] while making purchase decisions, consumers are often unable to evaluate all available alternatives in great depth and, thus, tend to use two-stage processes to reach their decisions. Interactive tools that provide support to consumers in the following respects are particularly valuable. To solve the problem systems of two types are required. The first interactive tool, a recommendation agent (RA), allows consumers to more efficiently screen the (potentially very large) set of alternatives available in an online shopping environment. The second decision aid, a comparison matrix (CM), is designed to help consumers make in-depth comparisons among selected alternatives. The CM allows consumers to organize attribute information about multiple products in an alternatives attributes matrix and to have alternatives sorted by any attribute.

Recommendation system is a system forecasting content items to be of interest for a certain user in view of his/her profile details and recent activities. In addition, there are recommendation systems adhering to collaborative filtering approach which means producing recommendations to a certain user on the basis of preferences of users with similar interests. Methods employed by recommendation systems include, in particular, ranking items or rating items on a certain scale along with tracking user activities and search queries.

Comparison systems are based on different algorithms and known under various names like shopbots, comparison shopping agents, buyer's agents and aggregators. Comparison agents are online tools which are able to retrieve product and/or service details stored in various data sources, to aggregate data, and then to process the information and to make it available for prospective buyers through a certain web interface to facilitate online buying decision making. Said agents accumulate data relevant to three types: rating information, dissimilarities between certain products and experience gained by product users. Most of web comparison agents are attributed to price comparison agents enabling users to compare prices of goods offered by various suppliers.

Yandex.Market (Internet marketplace launched by Yandex Russian search engine) is an implemented comparison service. The service users can obtain required product details through a number of clarification queries or after filling in a number of forms. The service accumulates a variety of products and stores a lot of product attributes from a few to several dozen, which allows providing results in line with a user's needs. The search returns a list of links to items matching certain criteria. To select a certain supplier/seller a user shall follow a returned link. The service enables users to compose a review to a bought item and to rate a seller service. It's also possible to tabulate items as a summary alternatives attributes matrix accumulating numerical values of attributes for each selected alternative.

Yandex.Market comparison matrix is an example of non-flexible structure. A user cannot add/remove attributes (criteria) and can compare alternatives gaining his/her insight through available attributes (criteria) only. It should be noted that Yandex.Market users can compare goods prices and specifications but not consumer properties. Thus, the service does not answer the question which of alternatives (products) is the best match for a certain situation or for solving a certain problem.

There are many computer solutions facilitating search over the entire web or over a certain web site and/or focusing on retrieving search results most relevant to users queries.

There is a disclosed technical solution DERIVING STATEMENT FROM PRODUCT OR SERVICE REVIEWS and Patent Application Publication US 2011/0251973 A1, Int. Cl. G06Q 99/00, U.S Cl. 705/347, Publication Date Oct. 13, 2011, MICROSOFT CORPORATION (US). Reviews of products may be analyzed, and statements about the products may be made based on the analysis. Non-professional reviews (e.g., reviews of products written by ordinary consumers of those products) are often difficult to interpret, because different reviewers may apply different standards. When a large number of reviews are available, the reviews can be analyzed statistically to make comparative statements about the products or services reviewed. Sentiments expressed in the reviews may be assigned numerical values. These numerical values for specific products, or classes of products, may be analyzed statistically to determine how the sentiments about a specific product compare with the sentiments about a larger class of products. Using this analysis, a statement can be made, such as, “This television has very good picture quality compared with other televisions of the same price.”

The disclosed solution also comprises a component assigning numerical values to semantic items identified within consumers' reviews.

There is also a known engineering solution ALTUSE RATING APPLICATION and Patent Application Publication US 2010/0250462 A1, Int. Cl. G06Q 99/00, U.S. Cl. 705/347 30.09.2010, Wheeler et al. The present invention relates to the field of rating and evaluating user-generated content on an Internet site. More particularly, the invention relates to a method and system of rating how well product alternative uses work based on user feedback. What is claimed is:

An online method for rating and evaluating whether a product alternative use works, offers utility and its transformative value based on system tabulations and user responses to multiple variables' scoring the product alternative use detail as presented via website www.AltUse.com.

Embodiments of the invention comprise methods and systems that provide users with the opportunity to vote on and to rank product alternative uses based on their perceptions of whether the alternative use worked, its utility and value. Such voting on and ranking of specific criteria yields an AltUse Rating score, which tabulates and statistically compares the utility of one alternative use with all other alternative uses in the database. The goal of the invention is to identify those products that have alternative uses that help consumers save money, minimize waste and offer extended utility.

There is another engineering solution USER CONTEXT BASED DISTRIBUTED SELF SERVICE SYSTEM FOR SERVICE ENHANCED RESOURCE DELIVERY and Patent Application Publication US 2010/0049625 A1, Int. Cl. G06Q 30/00, Int. Cl. G06Q 50/00, U.S. Cl. 705/26, 25.02.2010, INTERNATIONAL BUSINESS MACHINES CORPORATION. Disclosed is a method and system of providing user context-based services over computer networks, using mechanisms for collecting and specifying one or more user context elements, each element representing a context associated with the current buyer state and having context attributes and attribute values associated therewith, mechanisms for collecting affective (emotive) data to inform the user context, and also an interactive graphical view to gain insight into available services for assisting in understanding available service information and making decisions on purchasing.

There is a known engineering solution CRITERIA-BASED STRUCTURED RATINGS, U.S. Pat. No. 8,122,371, Int. Cl. G06F 3/048, U.S. Cl. 715/780, 21.02.2012, Amazon Technologies, Inc. Criterion-based feedback allows users to provide useful information in a quick and easy to understand fashion. When information for an item is relayed to a user, the user is provided with the ability to provide feedback for any criteria relating to the item. In some embodiments, this feedback takes the form of a submission of a response to a question or statement pertaining to a criterion for the item. The user is able to create new responses if the existing responses do not adequately convey the feedback that the user wishes to submit. Further, a user can also submit entirely new questions and/or statements, along with corresponding new responses, that correspond to a criterion relating to the item. Such an approach provides flexibility for users to quickly and easily provide feedback on specific criteria that might be useful for other users viewing information for that item.

In spite of their obvious benefits (versus conventional search engines) all of the above solutions lack certain features which could significantly (both quantitatively and qualitatively) improve search for an alternative most suited for a user and maximize search result relevance. For examp e, in spite of the fact that Yandex.Market users can rate a certain alternative (product) and write reviews the service is not perfect in terms of facilitating choice-making process, which entails the need to read tens or even hundreds of reviews (comments). Thus, users either cannot read all reviews (comments) or, even if they have read all or most of reviews (comments), they turned out to be ‘buried’ under piles of information and cannot gain proper and clear insight. In addition, it is not guaranteed that published reviews (comments) have not been paid or written by goods sellers; in other words there are no guarantees that reviews (comments) do not mislead users with regard to goods properties. The list of shortcomings is not comprehensive as one can see from the invention to be disclosed as described below.

At the moment a search engine system attributed to the available prior art is a system consisting at least of the following:
A user terminal (any of currently available engineering solutions with an integrated or remote external memory module can be used as a user terminal); hardware and software to be connected to other similar devices or servers over any heal/global network; data processing software and/or hardware; data input and visualization tools (for input and derived data) such as personal computers of any types and forms including but not limited to desktops, laptops, tablets and hybrid computers, smartphones and phones (Alongside with the above said a user terminal shall have a feature to be connected to a server component comprising at least a search engine software component and at least one database arranged as a set of alternatives associated with at least one criterion.); hardware and software solutions transferable to a user terminal, contained in the server component and comprising the following blocks:
Alternative search block;
Criteria filtering block;
Alternative rating block enabling users to rate any alternatives;
Alternative appending block enabling users to append any alternatives which are not available in the database;
Criterion appending block enabling users to append any criteria which are not available in the database;
Review (comment) publishing block enabling users to review (comment) one or more alternatives;
Review (comment) publishing block enabling users to review (comment) one or more criteria (a certain criterion);
Parameter (alternatives, criteria, reviews (comments)) change tracking block to track changes made by users.

In view of the above prior art, the task was set as developing a search engine, data processing and rating system devoid of the above drawbacks and not only enabling users to get best possible search results in response to their search queries but also demonstrating shorter search response time, minimum amount of irrelevant or non-requested information in response to search queries, and enabling users to customize search process and to enrich the system content fullness along with the search result objectivity and relevance for other users.

### BRIEF SUMMARY OF THE INVENTION

Stated engineering result can be achieved through developing an information search engine system consisting of:

A user terminal (any of currently available engineering solutions with an integrated or remote external memory module can be used as a user terminal); hardware and software for connecting to other similar devices or servers over any local/global network; data processing software and/or hardware; data input and visualization tools (for input and derived data) such as personal computers of any types and forms including but not limited to desktops, laptops, tablets and hybrid computers, smartphones and phones; (Alongside with the above said a user terminal shall be connected to a server component comprising at least a search engine software component and at least one database arranged as a set of alternatives associated with at least one criterion.); hardware and software solutions transferable to a user terminal, contained in the server component and comprising the following blocks;
Alternative search block;
Alternative ranking block;
Block visualizing the averaged score based on scores specified by other users;
Block displaying a set of alternatives in view of score density;
Block to set criteria weight factors;
Block to adjust the averaged score in view of reputations of users involved into rating;
Filtering block visualizing the averaged score based on scores specified by other users being selected by the system in view of details accumulated by the system and/or known to a certain user;
Block visualizing the alternative averaged score density in view a number of users involved into alternative rating;
Block displaying an initial retrieval of alternatives in view of the fact how often other users selected criteria;
Block visualizing scores specified by another user;
Block filtering averaged scores based on scores specified by other users selected by the system in view of their activities;
Block enabling a user to rate an alternative by any criterion;
Block visualizing scores specified by a user himself/herself;
Block enabling a user to specify a score at alternative/criterion crossing at least through binary rating;
Block enabling users to review (comment) alternatives by any criterion;
Block enabling users to embed any known media objects into reviews (comments);
Block enabling users to review (comment) any criteria;
Block enabling users to review (comment) scores specified by other users;
Block enabling users to view meaning aggregated parts of reviews (comments) written by other users and relevant to alternatives associated with one or more criteria.

It should be noted that despite the fact that ‘alternative’ is referred through out the description as a consumable product, this meaning is not the only one; an alternative (an object of search) is not only a consumable product or service but any other tangible or intangible object not relevant to consuming but being, for example, a certain users interest such as a hobby, sports team, masterpiece of art, political or social phenomenon, sightseeing place and so on. As a result, a number (and type) of alternatives are limited only by the amount of tangible and intangible objects known or imagined at any time. Accordingly, the concept of a criterion to rate alternatives are not limited to one of consumable product attributes, and a number of criteria is not limited as well.

### BRIEF DESCRIPTION OF THE DRAWINGS

Description has been illustrated by the following figures:

FIG. 1 is a schematic arrangement of the proposed search engine, processing and information rating system.

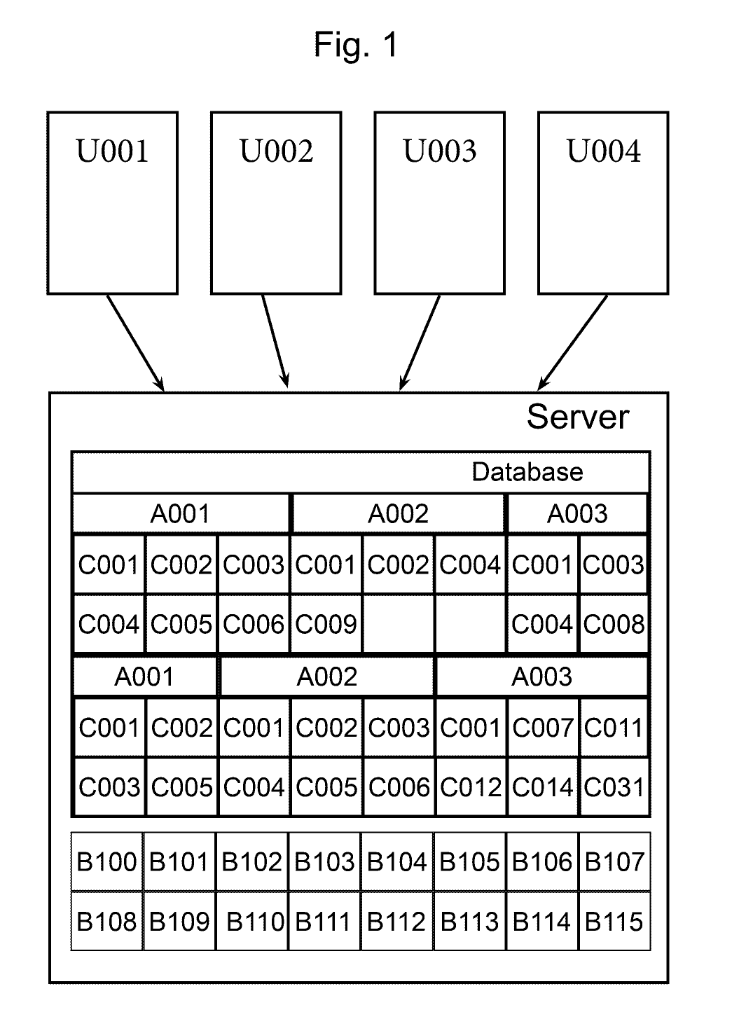

FIG. 2 shows an example of search results in response to a user query.

FIG. 3 shows a concept enabling a user to assess an alternative by a criterion.

FIG. 4 shows an example of rating approach used at amazon.com.

### DETAILED DESCRIPTION OF THE INVENTION

Users U001 U002, U003, U004, etc. are able to connect to the server containing the search engine software component and at least one database arranged as a set (containing at least two alternatives) of alternatives A001, A002, A003, etc. associated with at least one criterion K001 K002, K003, and so on: Also, the system server component contains blocks B100, B101, B102, etc. corresponding to the above-mentioned blocks: block enabling users not only to review (comment) and/or rate an alternative (and/or a criterion) using at least a binary scale but also to rate an alternative by any criterion; block visualizing scores specified by a user himself/herself; block visualizing scores specified by another user; block visualizing the averaged score based on scores specified by other users; block visualizing the alternative averaged score density by a certain criterion with regard to the alternative averaged score density by another criterion in view of a number of users involved into alternative rating; block to adjust the averaged score in view of reputations of users involved into rating; block enabling users to sort out the retrieved information; block displaying an initial retrieval of alternatives in view of the criteria selected by other users to rate the alternatives (in view of scores specified by other users); block enabling users to view meaning aggregated parts of reviews (comments) written by other users and relevant to alternatives associated with one or more criteria; block enabling users to review (comment) scores specified by other users; The system has also other code blocks not shown in the figure such as block enabling users not only to review (comment) and/or rate an alternative (and/or a criterion) using at least a binary scale but also to rate an alternative by any criterion.

The system operates as follows.

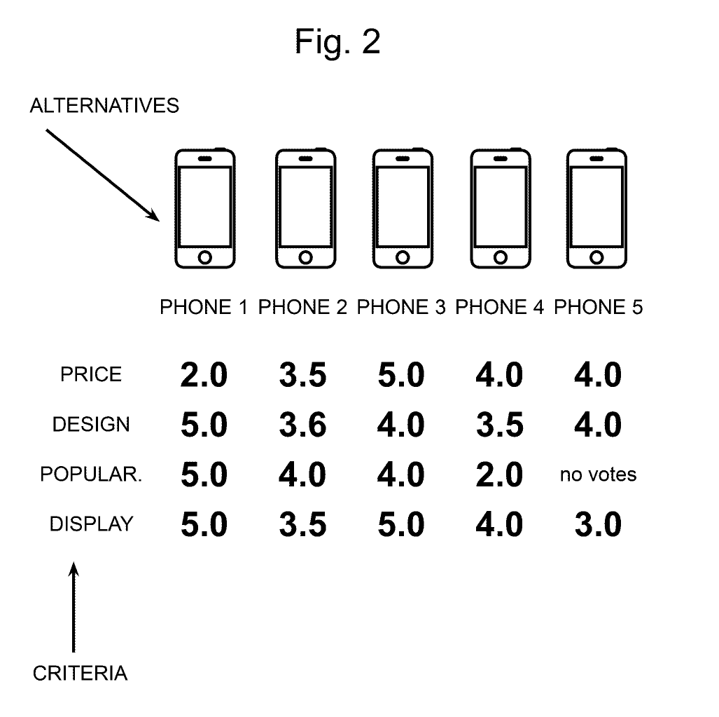

User U001 using his/her terminal enters a search query. The query can be entered using text or graphics format and any software tool connected to the server and sending/receiving information to/from the server, for example, using any web browser. The solution applications are not limited to the World Wide Web, and implementation over a local area network is also possible. A search query received by the server component is processed by the alternative search block and after processing the search result is displayed for a user as a two-dimensional alternatives-by-criteria matrix. Alternatives and criteria have been specified and associated between each other beforehand. Each alternative has been already associated with a number of criteria, but this number is changeable (it's possible to add new criteria) by the system owners and/or by users. FIG. 2 shows an example of search results in response to a user query.

The example provided for reference only and not containing users' actual scores shows the search result to a query ‘smartphone’. The specific example shows a list of alternatives limited to six (smartphone models) and a list of criteria limited to four (price, design, popularity, screen). The real system is capable of returning in response to this broad query a number of alternatives limited by the number of alternatives (smartphones) contained in the system only. A number of criteria in the implemented system is limited by a number of all possible criteria theoretically applicable to a certain alternative; the criteria may be attributed to strictly objective ones (for example, product size) or to quite subjective ones (product design), or to entirely subjective (like/dislike or any not so significant product detail).

As it can be seen from FIG. 2 each crossing between columns (alternatives) and rows (criteria) contains a digital value that is scores specified for at least one alternative by at least one criterion by other users U111, U112 (and so on) who already were involved into search for similar alternatives. The example shows scores specified using five-point, scale, which is not the only embodiment of rating process, it's possible to use any numeric scale of any dimension or any graphics reflecting a criterion attributes as well or to arrange more specific rating through pre-set scores (excellent, good, satisfactory, bad and so on). The described function is implemented through a block visualizing the averaged score based on scores specified by other users.

The proposed system differs from known solutions enabling users' search for alternatives due to an alternative ranking block.

Essentially, the block can be considered as a number of blocks through which various filters have been implemented in view of various, parameters specified in a search query. Generally, the alternative ranking block uses the following alternative ranking algorithm.

A user creates a search query and in response to his/her query the system returns an alternatives-by-criteria matrix where alternatives have been ranked in view of preset criteria (the criteria show importance and/or relevance of certain attributes/properties for most of users). Then the system enables the user to adjust the search result. For example, users can adjust criteria weighting factors relative each other to show that some criteria are more significant and other are less significant in view of personal relevance. Then system re-ranks alternatives taking into account re-arranged set of criteria and returns a set of alternatives ranked in view of this set of criteria with adjusted weighting factors.

The system also can rank alternatives taking into account weighting factors adjusted (or assigned) by a certain group of users only if the group specified scores for alternatives by criteria. The groups can be defined, for example, in view of stated social status, published interests, or recent activities within the system. In this case the system also re-ranks alternatives and returns a search query result which is sensitive to a set of criteria re-arranged by a certain group of users.

The algorithm can be implemented through a number of blocks incorporated into an alternative ranking block in full or partly (or through the only block) such as:

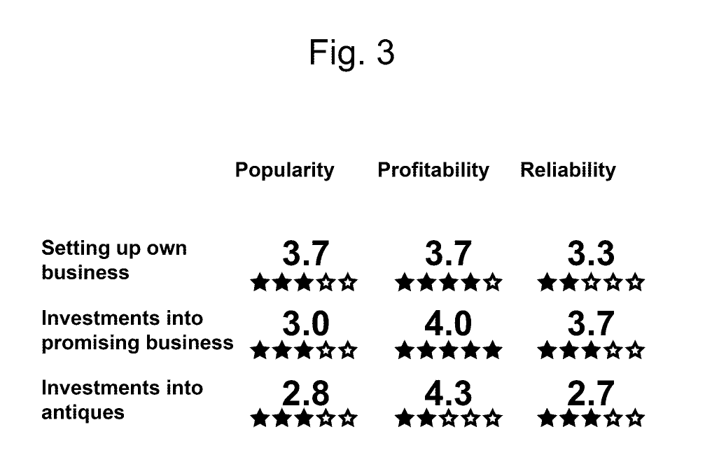

The first block is a block visualizing the alternative averaged score density by a certain criterion with regard to the alternative averaged score density by another criterion in view of a number of users involved into alternative rating. FIGS. 3 and 2 show that various averaged scores differently saturated with color, this feature can be described in the system manual, but it must be easy for users to understand that averaged scores which are more saturated with color (irrespective of their numeric values), in other words, scores having more density, mean the averaged scores based on scores accumulated from a larger number of users involved into rating, comparing to scores which are less saturated with color. Such score color saturation is one of possible solutions to visualize the averaged score density but not the only one. For example, it's possible to use numeric values of various sizes (or different fonts) and so on. The block also enables users to view a number of users who specified their scores for a certain alternative by a certain criterion, which is not shown in the screenshots. However, in this embodiment, when the mouse pointer is on an averaged score, a numeric value representing a number of users who specified their scores will appear on the screen. The described is a kind of implicit ranking.

The alternatives-by-criteria matrix returned in response to an initial search query can be considered as an aid for a user because by default it displays an averaged set of criteria and their relevance (averaged weighting factors) for other users, thus, a user can judge ‘fairness’ of scores specified for alternatives by certain criteria.

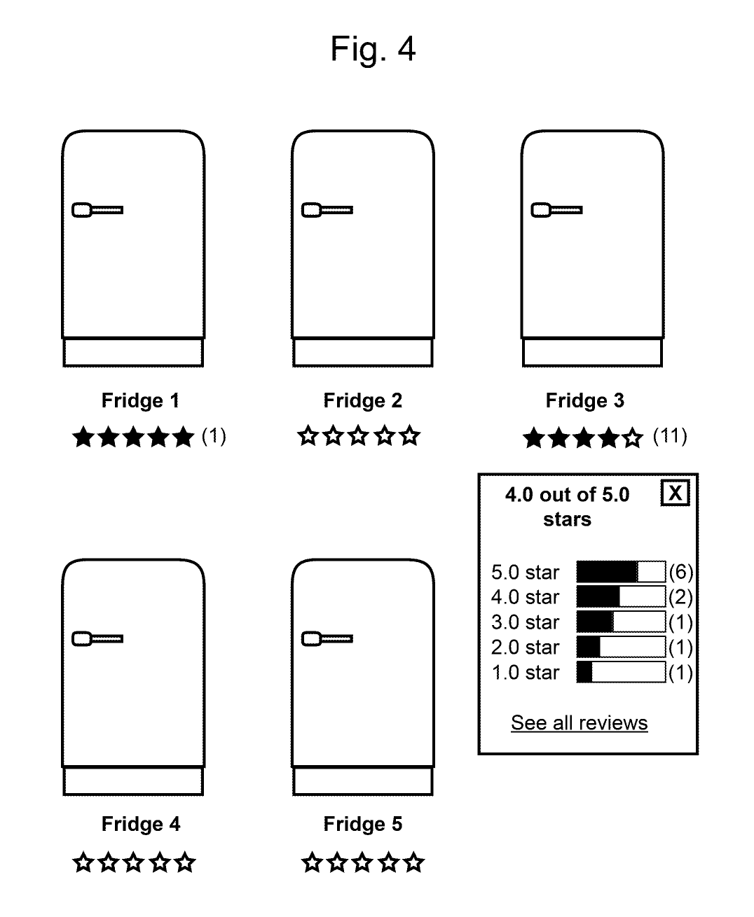

It's not always helpful for users (or consumers involved into product comparing) to use averaged ratings for alternatives ranking (Score=Averaged rating=(Positive ratings)/(Total ratings)) because the outcome is not always fair. Averaged rating works fine if you always have a ton of ratings ((http://www.evanmiller.org/how-not-to-sort-by-average-rating.html)) but, for example, we see at amazon.com (FIG. 4) that if a fridge has 1 positive rating only and 0 negative ratings this fridge will be put at the top as the highest-rated one comparing to another fridge having, for example, 5 positive ratings and a few negative ratings. It is also wrong if suppose item 1 has 2 positive ratings and 0 negative ratings and suppose item 2 has 1000 positive ratings and 5 negative rating. This algorithm puts item two (tons of positive ratings) below item one (very few positive ratings). The disclosed invention solves the problem. The system enables users not only to adjust criteria weighting factors but also makes it possible to switch on/off an option to take into account/to omit taking into account score density (an option taking into account a number of votes) when alternatives ranking. The system prompts users to enter a separate weighting factor which numerical value shows if a number of ratings at alternative/criterion crossings is important or not for a certain user. Assigning of such a weighting factor (a score density factor) directly affects ranking (a search result). The highest-rated alternative may differ due to adjusting the factor. Adjusting of this factor is relevant to hampering/encouraging alternatives having not so many ratings to be ranked as top ones in terms of a certain criterion. Thus, we have a kind of dynamic rating because the system enables users to customize any item of the ranking algorithm in accordance with their preferences.

The function has been implemented through a block displaying a set of alternatives in view of score density.

The key block in charge of alternatives rating is a block to set criteria weight factors relative to each other. Suppose that an initial response to a search query shows that all criteria used to alternatives have the same weighting factor. In other words, if, for example, an alternative is rated with 5 criteria, each criterion weight is 20%, irrespective of the fact if a criterion is important or, opposite, ambiguous to obtain a fair score for the alternative. It is natural that different users value criteria relevant to a certain alternative in various ways in view of personal relevance.

Thus, if users are looking for airlines having flights to certain destinations some of them can be focused on aircraft types, and some of them can, for example, consider ticket prices and availability of open date tickets as important, the third part of users value service level and variety of board food choices. As a result, a user attributed to any said group can assign a large weighting factor to a criterion which is of importance (or of interest) for him/her (can combine weighting factors according to his/her preferences). The criterion weighting factor set can be as follows: service level 40%, food choices 30% and aircraft type 20%, remaining 10% may be distributed among remaining criteria (weighting factors of certain criteria may be set to zeros). After assigning weighting factor to the criteria and sending the second request the system alternative search block and the alternative rating block returns the search result where the top positions are occupied by the airlines high-rated by the criteria to which the user assigned high weighting factors, which means that the system rates alternatives.

The next system block is a block to adjust the averaged score in view of reputations of users involved into rating (users who already specified their scores for certain alternatives by certain criteria).

There are known computer systems where users are enabled to rate (to rank, to set reputation) of other users or reviews (comments) published by other users. It is natural that those opinions/reviews/comments published by users having higher reputations (by so-called ‘experts’) are more valuable and meaningful for other users.

However, known systems providing a user's reputation details to other users do not refer to scores specified by experts and have no underlying structure. The proposed solution due to the block in question enables users to omit scores specified by users whose reputation is below a certain level when displaying averaged scores. Thus, the system enables users to view alternative averaged scores accumulated with scores specified by experts only, which can be of more significance for a user comparing to averaged scores accumulated with all specified scores.

Thus, the system enables users to view alternatives-by-criteria averaged scores specified by users attributed to a certain user groups defined in view of reputations earned by the system users (for example, one can view opinions of users having a certain status (a newcomer, a user, an advanced user, expert, moderator).

User reputation is gained and statuses are awarded through feedback of other users who rate usefulness of alternative-by-criterion comments (reviews). In fact, alternative-by-criterion comments (reviews) may be considered as detailed grounds underlying certain specified scores. Usefulness of the comments (reviews) is rated by other users with a conventional binary (like/dislike) or a point scale.

Another block relevant to alternatives ranking is a block enabling users to sort criteria averaged scores in view of a certain group of users involved into rating of an alternative by a criterion. In addition to experts averaged scores the system enables users to view adjusted scores based on, for example, social relations between a certain user and other users (friends and family opinions, or scores specified by users attributed to a certain social group). In calculating averaged scores of this type to respond to a user's query the system tracks the details published by users and associated with them. As an example we can consider obtaining averaged scores for such alternatives as higher educational institutions through accumulating scores specified by professors/current students/former students only. Similarly, users are enabled to get averaged scores for higher educational institutions by those who are not professors/current students/former students and so on. Averaged scores accumulated with the block in question are of more value for a user comparing to averaged scores accumulated with scores specified by all users.

One more block relevant to alternatives ranking and enabling users to adjust the search result is a block displaying an initial retrieval of alternatives; the alternatives are retrieved by the system with regard to the fact how often other users select certain criteria.

An alternative can be associated with tens or even hundreds of criteria. The system is capable of returning tens or hundreds of alternatives in response to a user's query. It is clear that users are not able to consider a lot of alternatives displayed as a long list or a table containing hundreds of rows and columns. To avoid such a. ‘heavy’ search result the system comprises a block taking in account scores specified by other users and assigning weighting factors to the criteria related to a certain alternative, which makes it possible to display initially the most relevant search results based on criteria which are oftener used to rate a certain alternative.

The system embodies a block visualizing scores specified by another user. As it was already mentioned, scores specified by users for alternatives by criteria are stored in the score database located on the server; the database can be arranged as a part of alternative/criteria database or as a separate score database. Any scores are displayed for a user in response to his/her query. Sometimes users are interested (and sometimes it's of importance for them) to view scores already specified for an alternative by a certain person.

The system also comprises a block filtering averaged scores based on scores specified by other users selected by the system in view of their activities within the system.

Its also possible to arrange search for alternatives and their scores by criteria while retrieving only those scores which were specified not by all users, and not by a certain social group of users but only by those users who, for example, created a certain number (or a number which is not less than a certain number) of queries for a certain period or who published a certain number of reviews (comments) and/or specified a certain number of scores to certain alternatives. Defining of such groups of users is not limited to the above examples, and any approaches and details are possible and, for example, recent users' activities combined with details published by users can be used to define a group of users.

Any applied filters change the data retrieval to be used to rank alternatives in the form of matrix. Users are free to set attributes of groups of users whose opinions shall be taking into account for ranking. The groups of users are defined in view of:
Activities (for example, to display votes of only those users who created search queries containing building materials' as key-words; or to display votes of those users who bought a certain smartphone over an Internet shop);
Certain time elapsed after user's activity;
A user's efforts within the system (for example, not to count in ranking the votes of those users who published more than 1000 of reviews about a certain brand to discard allegedly paid reviews);
Users' opinions (for example, to count in ranking the votes of only those users who made certain statements; if we filter those who said ‘cool’ it will be possible to see the problem through the eyes of optimists and to transfer an emotional response into a quantitative characteristic);
Any openly published user profile details (for example, openly published interests).

Generally, the data retrieval is not limited to a response from a certain block and to ensure maximum retrieval precision and effectiveness a combination of blocks is required. As applied to the above example of the search for airlines, a user may create the following query: search for the best alternative which shall be an air company having maximum scores by service level criterion and those scores shall be specified by men older than 35 who specified scores for at least 5 similar alternatives (airlines or air carriers) and having reputation which is equal at least 3.5 points.

As an example we can also consider ranking of regions in terms of investment attractiveness.

Investment attractiveness criteria may be selected arbitrary. They, for example, may include attracted investments (experts' estimates of investments into the region development), investment strategy and even effectiveness of the regional government investment appeal for more investments. Experts, businessmen, government representatives, foreign partners and households may be involved into voting. An additional weighting factor may be used to adjust importance of various groups in ranking. The weighting factor may be a combined one to be set through adjusting constituent weighting factors.

The system purpose is broader than an effective search engine for most relevant alternatives because it enables user to share his/her opinion to shape fair public opinion about alternatives. There is a number of system blocks enabling users to rate and describe alternatives. For example, a user himself/herself can specify scores for one or a few alternatives or for all displayed alternatives using the server block enabling users to specify a score (at least through binary rating) for a certain alternative by any criterion along with the block visualizing a user's scores. Various system embodiments may use various scales; scores may be specified using graphics or character approaches including a binary scale, that is a user may be prompted to check ‘plus’ or ‘minus’, ‘yes’ or ‘no’ controls and so on. The described alternatives-by-criteria scores specifying and visualization have not been implemented by now at any available or at least disclosed solutions and is a key feature of the proposed solution. Any score specified by a user for any alternative by any criterion is entered into the score database located on the server; the database can be arranged as a part of alternative/criteria database or as a separate score database linked to the alternative/criteria database. Scores accumulated by the system are used by the system to count alternatives-by-criteria averaged scores with known mathematical methods. To obtain averaged scores such methods as arithmetical averaged along with median-based approach and score mode calculating; the system is capable of calculating of averaged scores for each alternative by each criterion. FIG. 3 shows a matrix form to be used by users to specify scores for alternatives by criteria. Each cell of the two-dimensional alternatives-by-criteria matrix contains an averaged score (a numerical value calculated used scores specified by other users) and graphical symbols (five stars) to enable users to specify scores (five-star rating).

Then, using a block enabling users to review (comment) an alternative by any criterion a user can publish his/her review (comment) to any alternative by a certain criterion, by a few criteria or by all available criteria. Alongside with the feature enabling users to specify scores at each crossing of alternatives and criteria as disclosed above the reviewing (commenting) alternatives by criteria is also a new feature with regard to available prior art. A number of systems enable users to review (comment) alternatives but these reviews (comments) are linked to alternatives and not to their certain criteria. All alternatives-by-criteria comments (reviews) published by users are stored in the comment (review) database located on the server; the database can be arranged as a part of alternative/criteria database or as a separate comment (review) database linked to the alternative/criteria database.

Then, the system block enables a user to specify a score at least through binary rating for any criterion. The approach enables users to defined averaged scores for criteria. It is obvious that criteria relevant to alternatives are of not the same importance for users. For example, such a criterion as ‘product price’ is of high importance (and higher-rated) for most of users involved into the search for a certain product (an alternative), which is relevant to all priced alternatives; such a criterion as ‘product overall dimensions’ is of importance for not so many users and relevant to a less number of alternatives (the criteria is more or less the same for similar alternatives). Thus, once the system accumulates some scores for criteria, in response to their queries (initial and detailed) users are able to retrieve a set of alternatives rated by five criteria attributed by other users as the most important ones or by three criteria rated as the most unimportant ones, and so on. Similar to alternative scores, criterion scores may be specified using a binary scale (a user may be prompted to check ‘plus’ or ‘minus’, ‘yes’ or ‘no’ controls, and so on) or using graphics or character approaches. Any score specified by a user for any criterion is entered into the criterion score database located on the server; the database can be arranged as a part of alternative/criteria database or as a separate criterion score database linked to the alternative/criteria database. Known mathematical methods such as arithmetical averaged along with median-based approach and score mode calculating are used to obtain averaged criterion scores. The system is also capable of displaying (or visualizing) a set of alternatives having the same or similar criteria being of importance (for example, it is possible to display a set of alternatives for which among other criteria such a criterion as product weight is important; ultrabooks, kids' rucksacks, and so on may be attributed to such alternatives (products)).

Then, using a block enabling users to review (comment) any criterion a user can publish a comment to any criterion. Alongside with other disclosed features the disclosed functionality is also a new one with regard to available prior art. Any review (comment) published by a user for any criterion is entered into the criterion review (comment) database located on the server; the database can be arranged as a part of alternative/criteria database or as a separate criterion review (comment) database linked to the alternative/criteria database.

Blocks enabling users to review (comment) scores specified by other users and to rate any other user have been implemented in a similar way. Any review (comment) published by a user for any score along with any reputation rating specified by a user for another user are entered into the score review (comment) and user reputation rating databases located on the server; the database can be arranged as a part of alternative/criteria database or as separate score review (comment) and user reputation rating databases linked to the alternative/criteria database.

In addition to a block enabling users to review (comment) scores the system comprises a block enabling users to embed any known media objects into reviews (comments). Media objects include graphics, sound, animation and video objects embedded into a review (comment) or being a review (comment) as such.

Also, the system incorporates a block enabling users to view meaning aggregated parts of reviews (comments) written by other users and relevant to alternatives associated with one or more criteria. As it was mentioned above a user is able to review (comment) any alternative and any criterion related to the alternative. In addition, a user reviewing (commenting) an alternative (or editing his/her review (comment)) is able to link a certain part of his/her review (comment) to a certain criterion. In response to a query covering the retrieval from reviews (comments) relevant to an alternative/criterion pair the system returns the search result comprising not only alternative/criterion reviews (comments) but also relevant parts of general reviews (comments).

The system enables users to view structured public opinions broken down by criteria. Each review (comment) linked to an alternative/criterion crossing is a pro or contra argument (in support of a positive (or negative) rating). Reviews (comments) linked to crossings between alternatives and criteria enables users involved into comparing alternatives to consider a problem from different points of view and to gain an idea of further criterion drilling down. For example, while analyzing reviews (comments) opinions relevant to such a criterion as security it is possible to decompose the criterion to such constituents as aircraft maintenance before flights, de-icing fluid quality, and other attributes. While comparing cameras in terms of arrays such issues as image details in the shadows (image sharpness) (for landscape photographers) or increased sensitivity (for news reporters) may be of importance. The proposed decomposition and aggregation of reviews (comments) through linking to certain semantics save time of users involved into comparing alternatives.

Being a social network (a tool for social communications) the system through filtering enables users to find persons thinking in the same way, for example, it is possible to find people who specified the same scores as a certain user did.

In conducting research and producing research studies one can use the system to decompose and aggregate arguments which are pro or contra to a proposed hypothesis.

It is possible to use the system for brainstorming (at corporate or friends and family level). If a task has not been set yet by a group it can be clarified through adding new brainstormed alternatives and criteria. Breaking down of any problems into alternatives and criteria is of help for assessing a current situation, available resources, or performance improvement approaches.

Thus, the proposed system is capable of solving the set engineering task and is an easy-to-use and efficient information search engine, processing and rating tool.

The key feature setting the system apart from other systems containing alternatives-by-criterion matrices or product comparison matrices is data accumulating by voting (rating/specifying score) at alternative/criteria crossings so the system matrices finally accumulates users' scores instead of attribute numeric values. For example, a conventional mobile operator coverage area comparison matrix shows values in square kilometers but the proposed matrix shows five-star ratings based on users° personal opinion and satisfaction. The proposed system structures users' opinions and do not restrict users in terms of broadening a set of alternatives and criteria or in terms of narrowing to an only alternative and one criterion (attribute). Published reviews (comments) are also linked to alternative/criterion pairs. Thus, users are able not only to specify scores but also to support their opinions in word. Initiating a retrieval from the accumulated array of scores and reviews (comments) a user defines which alternatives and by which criteria are desirable for comparing and also set weighting factors for each criteria (in view of personal importance of each criteria).

In view of a problem to be solved by a user he/she may complicate or simplify data retrieval returned in response to a search query. It is possible to filter the accumulated data array and to display various, opinion surveys (for example, the best camera for holidays from students' point of view). Users are able to view opinions of friends or experts' opinions only (experts are users gained reputation among the community members through answering questions relevant to a subject) or opinions of any other group to be defined by a user. Thus the system enables users to discard data which are irrelevant (useless) for a certain user and to adhere to opinions of those advisers whose opinions are of interest for him/her. For example, users are able to filter scores and to define groups of users in view of openly published interests, or, opposite, to initiate voting on an interesting subject and to invite for the voting restricted audience. The system experts are gaining their reputations when other users rate their contributions to a certain subject development. Scores specified by users attributed to an expert panel are weightier for a certain subject. Said parameter is taken into account through score density graphical visualizing. Personalized and structured data displaying is of help for understanding the content and making a better decision. The described functionality, in essence, is a transformation of accumulated practical experience into understandable and useful knowledge, as well as also an attempt to include an analytical component into the incoherent content. Modern search engine ranking algorithms are seeking higher levels of retrieval precision and effectiveness through personalization, are using, for example, contextual approach and analyzing target audience behavior. Using the disclosed system users are provided with a personalized set of alternatives (search result) and users are able to assign weighting factors to each criterion relevant to a certain alternative. Such weighting factors reflect personal significance of a criterion for a user. Weighting factors displayed on the screen by default reflect the users audience majority opinion obtained through analyzing users' preferences, which makes it possible to find out criterion averaged relevance for the user audience. Users comparing alternatives are able to set any ranking constituents in accordance with their preferences and needs. The proposed system returns ranked alternatives based on settings specified by a user involved into decision-making in accordance with his/her preferences. The proposed tool is designed in a broad sense to improve decision-making efficiency irrespective of options being compared (it may be attributes of goods, ranked restaurants or alternative ways of solving social problems).

Users are able to add new alternatives-by-criteria matrices and to share with the community or with a select group of users some ways of solving a certain problem. Feedback in the form of alternatives and criteria contributed by other users in addition to already available ones enables further detailing of discussions. Initiated discussions may be open or closed for public access. Generally, the described approach enhances the depth of interaction between the society members at the peer-to-peer level (between peer users) and combines such concepts as folksonomy (collaborative content categorizing) and recommendation system.

Applying group-focused filters is an easy way to get quick advice from a certain group over Internet. Voting at crossings between alternatives and criteria is not only an easy way for groups to make a decision (for example, which of nightclubs is preferred by student mates) but may be considered as a tool for shaping the public opinion through focusing on and encouraging to use new, untried alternatives, which indirectly, may, for example, influence consumer demand. Composition and weighting factors of criteria are unique for each individual. Dynamically reconfigurable profile of criterion weighting factors is a statistics, since it reflects the weighted averaged audience opinion about criteria significance. The system can be useful for marketers assessing customer satisfaction. Social scientists can use the system to obtain opinion surveys. As data are being accumulated the averaged scores fairness is being increased, which may be of interest for decision-makers at all levels through tracking emerging trends.

The system enables users to aggregate reviews (comments) in accordance with their meaning and to decompose them into meaningful items linked to scores. Described structuring enables users to handle large amounts of data facilitating fast considering available information (content) and to be aware of opinions expressed by an unlimited number of people. The described aggregation and decomposition increase the value of information for users and save their time because they do not need any more personally to look through a lot of reviews (comments) including noise content and insignificant information. The breakdown into semantic items and further clustering enables users to track instantly discussion brunches and trends and not to waste time. Due to the described functionality users are capable of considering more pieces of information at a time.

Having decomposed reviews published by a recommendation system and having entered scores into the described comparison matrix one often can notice distortions caused by a large number of positive reviews covering certain brands. However, statistical data may reflect the fact that these brands are not the most popular ones. Advertisers are spending budgets to shape consumer opinions but sometimes it, the opposite way, entails a lack of confidence among consumers. Opinion survey fairness is subject to a number of people involved (the larger the sample is, the more objective opinion survey is). Currently IPhone 4S reviews, for example, at amazon.com count about eight hundred, which is not representative. Thus, available systems are rather selection engines than recommendation systems. The greater critical mass gains the proposed system, the greater its usefulness will be.

Integrated use of the above functionality enables users to get a personalized ranking taking into account scores specified by relevant audience. Voting at the crossings between alternatives and criteria makes scores fairer, since specified scores are relevant to one specific criterion (parameter, attribute) of an alternative. The system solves the problem of personalized content filtering based on defined parameters or links. Users are provided with the most relevant ranking reflecting their needs through persona settings. Despite the obvious need for such a system there is no Internet implemented system like that.

The key features of the proposed system are mass voting at crossings between alternatives and criteria and further detailing, adding and removing of alternatives and criteria. The proposed system fits into the concept of the transition from web 2.0 to web 3.0: from collective content creating to information personalizing with no artificial intelligence since the method is not able at the moment to solve the set problem in full. Modern expert systems have not reached yet the intellectual level at which one can get answers to questions like which car is best suited to a certain person, and often are ineffective in attempts to help people in solving the problem of choice. Involving crowdsourcing-resources makes decomposition and synthesis possible, in spite of the fact that modern automated systems are not capable of it. Perhaps, the approach will be of help for promoting not known but high-quality brands or some new innovative solutions.

What is claimed is:

1. A search engine, processing and information rating system comprising at least one user terminal connectable to a server component comprising at least one database arranged as a set of alternatives associated with at least one criterion, an alternative search block and an alternative ranking block.

2. The search engine system according to claim 1 wherein said system also comprises a block visualizing the averaged score based on scores specified by other users.

3. The search engine system according to claim 1 wherein said system also comprises a block displaying a set of alternatives in view of score density.

4. The search engine system according to claim 1 wherein said system also comprises a block to set criteria weight factors.

5. The search engine system according to claim 1 wherein said system also comprises a block to adjust averaged scores in view of reputations of users involved into rating.

6. The search engine system according to claim 1 wherein said system also comprises a filtering block visualizing the averaged score based on scores specified by other users being selected by the system in view of details accumulated by the system and/or known to a certain user.

7. The search engine system according to claim 1 wherein said system also comprises a block visualizing the alternative averaged score density by a certain criterion with regard to the alternative averaged score density by another criterion in view of a number of users involved into alternative rating.

8. The search engine system according to claim 1 wherein said system also comprises a block displaying an initial retrieval of alternatives in view of the fact how often other users selected certain criteria to rate certain alternatives.

9. The search engine system according to claim 1 wherein said system also comprises a block visualizing scores specified by another user.

10. The search engine system according to claim 1 wherein said system in addition comprises, a block filtering averaged scores based on scores specified by other users selected by the system in view of their activities.

11. A search engine, processing and information rating system comprising at least one user terminal connectable to a server component comprising at least one database arranged as a set of alternatives associated with at least one criterion and a block enabling a user to specify a score for an alternative by any criterion in cells of an alternatives-by-criteria matrix.

12. The search engine system according to claim 11 wherein said system in addition comprises a block visualizing scores specified by a user.

13. The search engine system according to claim 11 wherein said system in addition comprises a block enabling a user to specify a score for a criterion, at least through binary rating.

14. The search engine system according to claim 11 wherein said system in addition comprises a block enabling users to review (comment) alternatives by any criterion.

15. The search engine system according to claim 11 wherein said system in addition comprises a block enabling users to embed any known media objects into reviews (comments).

16. The search engine system according to claim 11 wherein said system in addition comprises a block enabling users to review (comment) any criteria.

17. The search engine system according to claim 11 wherein said system in addition comprises a block enabling users to review (comment) scores specified by other users.

18. The search engine system according to claim 11 wherein said system in addition comprises a block enabling users to view meaning aggregated parts of reviews (comments) written by other users and relevant to alternatives associated with one or more criteria.
